(19) United States
(12) Patent Application Publication
(10) Pub. No.: US 2025/0095906 A1
(43) Pub. Date: Mar. 20, 2025

(54) TRANSFORMER STRUCTURE, MANUFACTURING METHOD AND INTEGRATED CIRCUIT

(71) Applicant: Silergy Semiconductor Technology (Hangzhou) LTD, Hangzhou (CN)

(72) Inventors: Ke Dai, Hangzhou (CN); Jian Wei, Hangzhou (CN); Jiajia Yan, Hangzhou (CN)

(21) Appl. No.: 18/885,961

(22) Filed: Sep. 16, 2024

(30) Foreign Application Priority Data
Sep. 20, 2023 (CN) 202311218476.8

(51) Int. Cl. H01F 27/28; H01F 27/255; H01F 27/29; H01F 41/04

(52) U.S. Cl. CPC H01F 27/2804; H01F 27/255; H01F 27/29; H01F 41/041; H01F 2027/2809

(57) ABSTRACT

A transformer structure can include: a substrate encapsulating at least two windings that are isolated from each other, where each winding includes a coil body and lead-out terminals coupled to the coil body; and a magnetic encapsulation body encapsulating at least one side of the substrate, where the magnetic encapsulation body includes an insulating main material and magnetic particles dispersed in the insulating main material.

### RELATED APPLICATIONS

This application claims the benefit of Chinese Patent Application No. 202311218476.8, filed on Sep. 20, 2023, which is incorporated herein by reference in its entirety.

### FIELD OF THE INVENTION

The present invention generally relates to the field of power electronics, and more particularly to transformer structures, methods, and integrated circuits.

### BACKGROUND

As a necessary energy conversion device for most power converters, transformers are widely used in civil, industrial, medical, aerospace, and other fields. In recent years, due to demands of cost and space limitations of the power supply, the miniaturization and integration of power supply products have become even more important. Increasing the switching frequency of active devices can reduce the energy storage requirements of passive devices (e.g., magnetic devices, capacitors, etc.), thereby reducing the volume of passive devices. However, the size of the transformer may still be limited by the process.

### BRIEF DESCRIPTION OF THE DRAWINGS

FIGS. 1A and 1B are two schematic block diagrams of an example transformer structure, in accordance with embodiments of the present invention.

FIGS. 2A-2D are four cutaway views of an example transformer structure, in accordance with embodiments of the present invention.

FIGS. 3A-3F are step diagrams of a first example manufacturing method of the transformer structure, in accordance with embodiments of the present invention.

FIGS. 4A-4F are step diagrams of a second example manufacturing method of the transformer structure, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

Most transformers are composed of a magnetic core and a winding. Due to basic requirements of structural strength and assembly tolerance of discrete components, a transformer assembled with wire wound may not meet requirements of ultra-thin size, so this type of structure may generally be used in low-frequency (e.g., f<2 MHz) applications. For a transformer assembled with planar windings, the assembly process can be complicated due to assembly of the magnetic core and the planar windings based on printed-circuit board (PCB) or substrate printing.

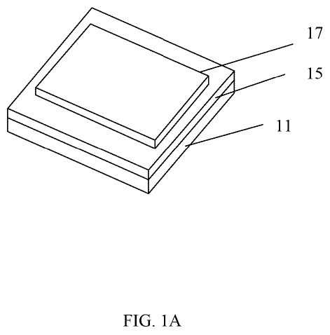

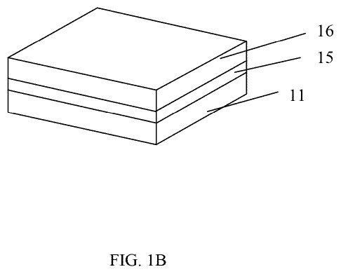

Referring now to FIGS. 1A and 1B, shown are two schematic block diagrams of an example transformer structure, in accordance with embodiments of the present invention. This particular example transformer structure can include substrate 15 encapsulating at least two windings, and magnetic encapsulation body 11 encapsulating at least one side of substrate 15. Each winding can include a coil body and lead-out terminals connected to the coil body. Magnetic encapsulation body 11 can include an insulating main material and magnetic particles dispersed in the main material. Here, the magnetic particles can include at least one of, e.g., carbonyl iron powder, alloy powder, micro-particle broken ferrite powder, and amorphous nanocrystalline powder.

As shown in FIG. 1A, when only a lower side of substrate 15 is encapsulated with the magnetic encapsulation body, an upper side of substrate 15 may also be attached with magnetic sheet 17, which can cover at least part region of all coil bodies. The magnetic sheet can include ferrite or magnetic powder core. In the example of FIG. 1B, the upper and lower sides of substrate 15 can be encapsulated with magnetic encapsulation bodies 11 and 16.

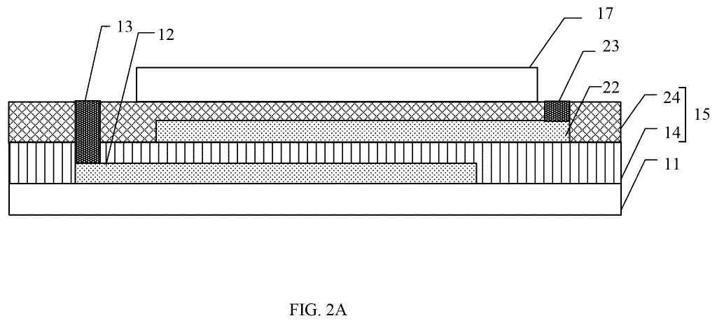

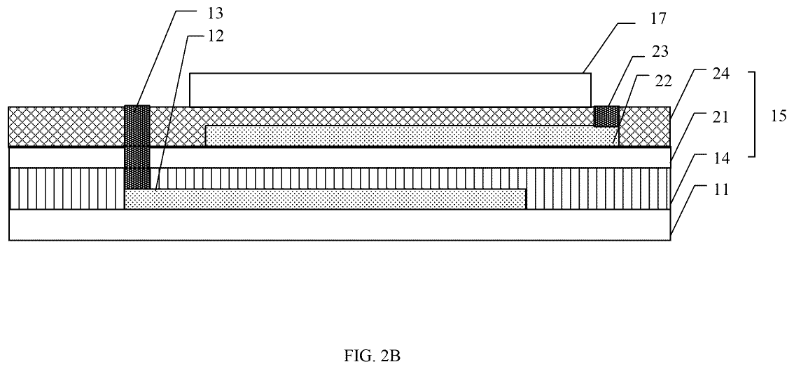

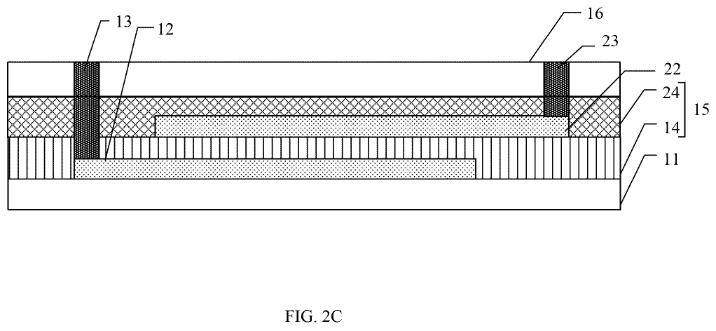

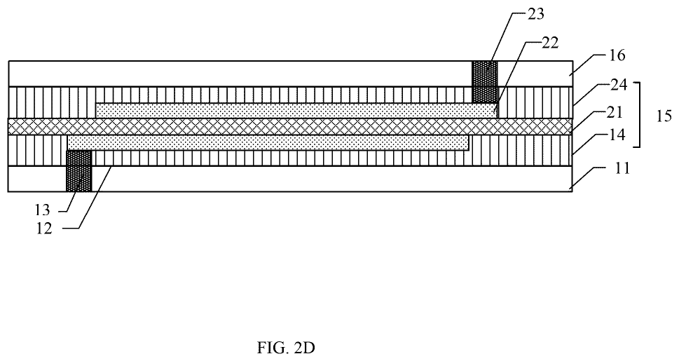

Referring now to FIGS. 2A-2D, shown are four cutaway views of an example transformer structure, in accordance with embodiments of the present invention. In this particular example, the four cutaway views of the transformer structure including two windings are shown. Substrate 15 can include package body 14 encapsulating coil body 12 of a first winding, and package body 24 encapsulating coil body 22 of a second winding.

In one embodiment, an insulating layer can also be arranged between two adjacent windings or between a primary side winding and a secondary side winding. The insulating layer can be located between package body 14 and package body 24, where a material of the insulating layer can include, e.g., epoxy packaging material or polyimide. The setting or arrangement of the insulating layer can improve the isolation characteristics between the windings and achieve high voltage insulation.

FIGS. 2A and 2B are two cutaway views of FIG. 1A, and FIGS. 2C and 2D are two cutaway views of FIG. 1B, whereby the lead-out terminals of different windings are partially drawn to the same surface of the transformer structure, such as the upper surface or the lower surface of the transformer structure as shown in FIGS. 2A, 2B, and 2D. Insulating layer 21 can be arranged between two adjacent windings as shown in FIGS. 2B and 2D. The lead-out terminals of the windings located on two opposite sides of insulating layer 21 in FIG. 2D can be drawn to the two opposite sides of the transformer structure. Also, the lead-out terminals of different windings shown in FIGS. 2A, 2B, and 2C can be drawn to the two opposite sides of the transformer structure. In FIGS. 2A-2D, the transformer structure can include two windings, and the two windings in FIGS. 2B and 2D may be located on both sides of insulating layer 21, respectively. In other examples, the number of the windings in the transformer structure can be greater than 2, and multiple windings can be located on both sides of insulating layer 21, respectively. Alternatively, other windings can be located on one side of insulating layer 21, and one of the windings may be located on the other side of insulating layer 21.

As shown in FIG. 2A, the transformer structure can include substrate 15 encapsulated with two windings, and magnetic encapsulation body 11 on the lower surface of substrate 15. Further, substrate 15 can include package body 14 encapsulating coil body 12 of the first winding, and package body 24 encapsulating coil body 22 of the second winding. The first winding can include lead-out terminal 13 connected to coil body 12, and the second winding can include lead-out terminal 23 connected to coil body 22. In this example, coil body 12 can be located at the bottom of package body 14, and coil body 22 may be located at the bottom of package body 24. Lead-out terminal 13 can be drawn from coil body 12 through package body 14 to an upper surface of package body 24, and lead-out terminal 23 can be drawn from coil body 22 through package body 24 to an upper surface of package body 24.

In FIGS. 2A and 2B, the transformer structure can also include magnetic sheet 17 located on the upper surface of package body 24. Magnetic sheet 17 may be located between lead-out terminals 13 and 23, and covering at least part region of coil bodies 22 and 23. Further, magnetic sheet 17 can cover at least part of a region of the overlapping area of coil bodies 22 and 23 in a first direction (e.g., a stacking direction) of the transformer structure.

The transformer structure in the example of FIG. 2B can include insulating layer 21, which can be located between the two windings. Further, insulating layer 21 may be located between package body 14 and package body 24, and substrate 15 can include package body 14, package body 24, and insulating layer 21. The upper surface of the transformer structure shown in the example of FIG. 2C can be encapsulated by magnetic encapsulation body 16. Also, lead-out terminal 13 of the first winding and lead-out terminal 23 of the second winding may both be drawn to an upper surface of magnetic encapsulation body 16.

The transformer structure shown in the example of FIG. 2D can include insulating layer 21, which may be located between the two windings. Further, insulating layer 21 can be located between package body 14 and package body 24. Also, substrate 15 can include package body 14, package body 24, and insulating layer 21. In addition, lead-out terminal 13 of the first winding and lead-out terminal 23 of the second winding on both sides of insulating layer 21 can be exposed to the two opposite sides of the transformer structure.

In particular embodiments, any suitable variation of the first package body and the second package body can both including the magnetic encapsulation material, or one of them including the magnetic encapsulation material in one not, or both not including the magnetic encapsulation material, are supported. When package body 24 does include the magnetic encapsulation material, according to the performance and parameter requirements of the transformer structure, magnetic sheet 17 attached to the upper side of substrate 15 in FIG. 1A, or magnetic encapsulation body 16 encapsulated on the upper side of substrate 15 in FIG. 1A, can be omitted. In this particular example, each winding may at least partially overlap in the first direction, while in other examples, other windings placed side by side with the first winding or the second winding can be formed.

An example method of making the transformer structure is described below, including the following steps. First, a substrate including at least two windings can be manufactured, and each of the windings can include a coil body and a lead-out terminal connected to the coil body. Next, at least one side of the substrate can be encapsulated by a magnetic encapsulation body. Here, the windings may be formed by an electroplating process in sequence. After one winding is formed, the winding can be encapsulated to form the package body, and the magnetic encapsulation body can include an insulating main material and magnetic particles dispersed in the main material.

In this particular example, the coil body and the lead-out terminal may be formed by an electroplating process, in which the electroplating process is the electroplating step in the metal redistribution process. Further, redistribution layer (RDL) is a packaging technology that redistributes the I/O pins from inside the die to the surface of the die for other connections thereto. This technology can improve the input and output density of the chip, reduce the packaging area, and also improve the performance and reliability of the chip.

An example process flow of RDL technology can mainly include the following steps. In substrate preparation, the chip substrate can be cleaned and other unwanted debris removed, in order to ensure that the substrate surface is smooth, clean, and free of any residue. In lithography production, the substrate surface can undergo lithography, in order to produce the required circuit patterns. In metallization treatment, after photolithography, the circuit pattern made on the surface of the substrate can be metallized for subsequent electroplating treatment. In electroplating treatment, the surface of the substrate can be covered with a layer of metal, in order to form a conductive circuit pattern. In etching treatment, after electroplating treatment, the excess metal part of the substrate surface can be removed, in order form the required circuit graphics. In deposition treatment, a protective layer can be deposited on the surface of the substrate, in order to protect the circuit pattern from damage.

In particular embodiments, the electroplating processing steps in RDL technology may be utilized to make the coil body and the lead-out terminal. For example, after lithography, the circuit patterns produced on the surface of the substrate can be metalized for subsequent electroplating processing. Next, the circuit patterns can be electroplated, in order to form the coil body and the lead-out terminals according to the circuit patterns.

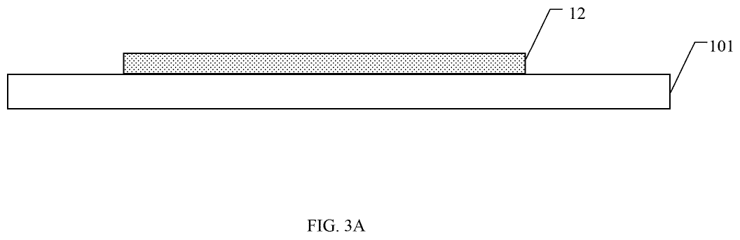

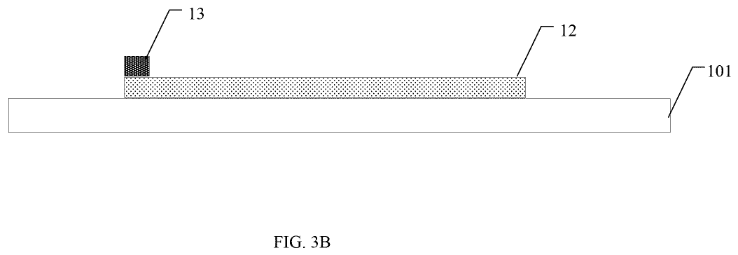

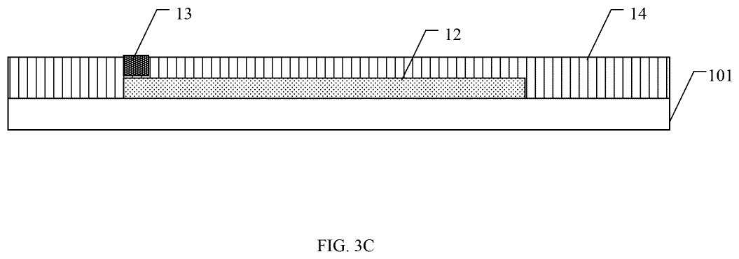

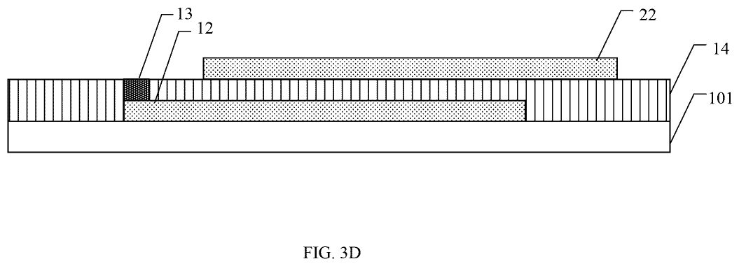

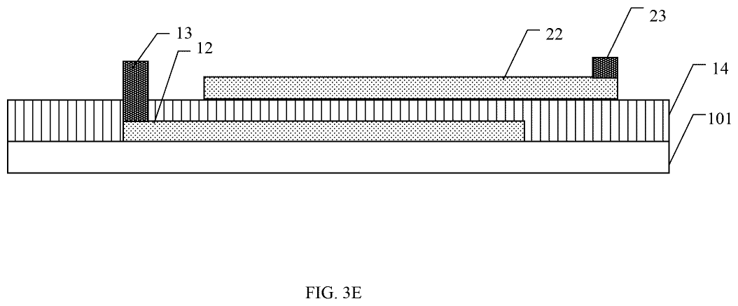

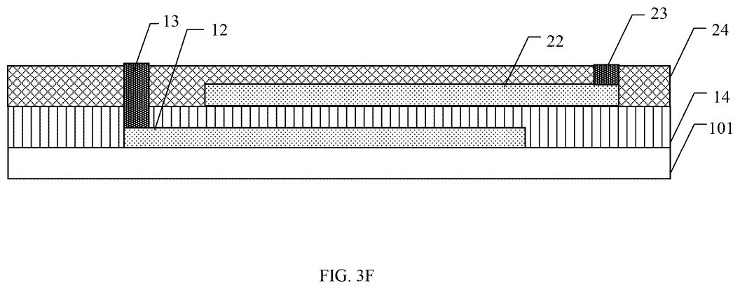

Referring now to FIGS. 3A-3F, shown are step diagrams of a first example manufacturing method of the transformer structure, in accordance with embodiments of the present invention. A first example manufacturing method of the transformer structure including two windings is described below. First, the formation step of the first winding is described. As shown in FIG. 3A, coil body 12 of the first winding (e.g., copper) can be formed by a copper plating process on base-plate 101. Further, a first layer photoresist can be coated to base-plate 101, and then the first layer photoresist may be exposed and developed, in order to form a first patterned photoresist on base-plate 101. The first patterned photoresist can include a window for the subsequent formation of the coil body. The circuit pattern may be formed on base-plate 101 exposed by the first patterned photoresist. That is, the circuit pattern can be formed at the window, and a first metal layer may be electroplated according to the circuit pattern, in order to form coil body 12.

In other examples, before the step of coating the first layer photoresist on base-plate 101, chemical mechanical polishing (CMP) of base-plate 101 can be utilized, in order to smooth surface of base-plate 101. CMP technology is a way to obtain global planarization in semiconductor technology manufacturing. In this way, the surface of base-plate 101 can be made flat without scratches and impurity stains. In CMP, the surface material of base-plate 101 can react with an oxidant catalyst in the polishing liquid, in order to form a soft layer that is relatively easy to remove. Then, the soft layer may be removed under the mechanical action of the abrasive and polishing pad in the polishing liquid, such that the surface of base-plate 101 is exposed again. Then, the chemical reaction may be carried out many times, such that the surface of the base-plate is polished in the alternating process of chemical action and mechanical action.

As shown in FIG. 3B, the copper column can be electroplated at the head and the tail parts of coil body 12 of the first winding, and the copper column can be configured as lead-out terminal 13 of the first winding. Further, a second layer photoresist may be coated on the upper surface of coil body 12, and then the second layer photoresist can be exposed and developed, in order to form a second patterned photoresist. The second patterned photoresist can include a window that subsequently forms a lead-out terminal. A second metal layer can be electroplated at the window to form lead-out terminal 13, and then the remaining first and second layers photoresist may be removed.

As shown in FIG. 3C, coil body 12 and lead-out terminal 13 of the first winding can be encapsulated, in order to form package body 14 including coil body 12 and lead-out terminal 13 of the first winding. Next, the formation steps of the second winding are explained. As shown in FIG. 3D, coil body 22 of the second winding can be formed by electroplating on package body 14. Also, coil body 22 of the second winding and coil body 12 of the first winding can at least partially overlap in a first direction.

As shown in FIG. 3E, copper columns may be formed by electroplating at the head and tail parts of coil body 22 of the second winding, in order to form lead-out terminal 23 of the second winding. As shown in FIG. 3F, coil body 22 and lead-out terminal 23 of the second winding can be encapsulated, in order to form package body 24 including coil body 22 and lead-out terminal 23 of the second winding.

In one example, base-plate 101 can include the magnetic encapsulation material, while in other examples base-plate 101 may not include the magnetic encapsulation material. When base-plate 101 does include the magnetic encapsulation material, the method of forming base-plate 101 can include pressing the material containing the magnetic encapsulation material to form base-plate 101. When base-plate 101 does not include the magnetic encapsulation material, after all the windings are formed, the lower surface of substrate 11 (e.g., including package body 14 and package body 24) can be encapsulated according to design or performance parameters, in order to form magnetic encapsulation body 11. In other cases, the lower surface of substrate 11 may not be encapsulated by the magnetic encapsulation material. When the lower surface of substrate 11 is not encapsulated by the magnetic encapsulation material, base-plate 101 may act as the lower cover plate of the magnetic core of the transformer and effectively play the role of magnetic encapsulation body 11. When base-plate 101 does not include the magnetic encapsulation material, after the formation of substrate 15, the lower surface of base-plate 101 can be encapsulated by the magnetic encapsulation material, in order to form magnetic encapsulation body 11.

Optionally, the materials of package body 14 and package body 24 and may or may not include magnetic encapsulation materials, and the inductance of the winding can be further increased when the magnetic encapsulation materials are included. When package body 24 does not include the magnetic encapsulation material, a magnetic encapsulation material can be formed on package body 24 to act as a cover plate of the magnetic core. In the transformer structure shown in FIG. 1A, magnetic sheet 17 can be attached on the upper surface of package body 24, and magnetic sheet 17 covers at least part region of coil body 12 of the first winding and coil body 22 of the second winding. In the transformer structure shown in FIG. 1B, magnetic encapsulation body 16 may be located on the upper surface of package body 24. When the material of package body 24 includes the magnetic encapsulation material, the encapsulation material of package body 24 can act as the upper cover plate of the magnetic core.

For example, lead-out terminal 23 of the second winding may be formed by electroplating at the head and tail parts of coil body 22 of the second winding, and lead-out terminal 13 of coil body 12 of the first winding can be formed by electroplating at the same time, and may be drawn to the outside of second encapsulation body 24. When magnetic encapsulation body 16 is formed on the surface of package body 24, and before the formation of magnetic encapsulation body 16, lead terminal 13 of the first winding and lead terminal 23 of the second winding can be electroplated to draw to the outside of magnetic encapsulation body 16.

Different application scenarios may have different withstand voltage requirements for transformers, and the step of forming insulating layer 21 on package body 14 can be added before forming the coil body of the second winding. When insulating layer 21 is included, the withstand voltage requirements of the transformer can be improved. The material of insulating layer 21 can include, e.g., epoxy encapsulation material or polyimide. The combination of insulating layer 21 and package body 14 can include, e.g., high temperature pressing or pasting. Insulating layer 21 between the first package body and the second package body can be arranged according to the different withstand voltage requirements of the transformer.

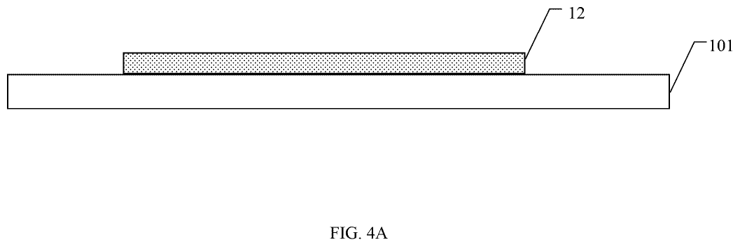

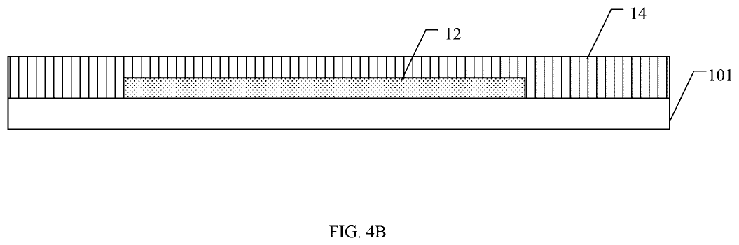

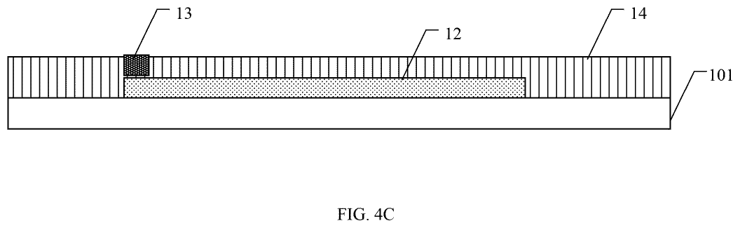

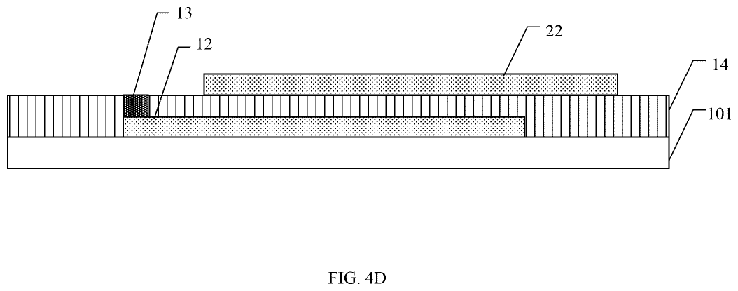

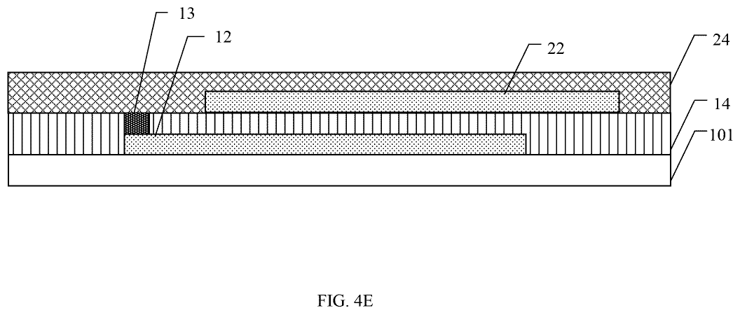

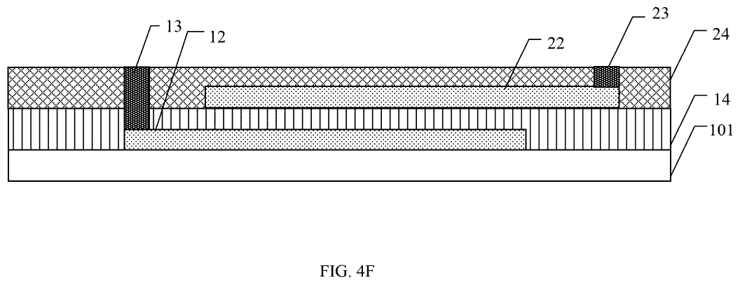

Referring now to FIGS. 4A-4F, shown are step diagrams of a second example manufacturing method of the transformer structure, in accordance with embodiments of the present invention. The second example manufacturing method of the transformer structure including two windings is described below.

First, the steps of forming the first winding are described. As shown in FIG. 4A, coil body 12 of the first winding may be formed by electroplating copper on base-plate 101. As shown in FIG. 4B, package body 14 can be formed by encapsulating coil body 12 of the first winding. As shown in FIG. 4C, through-holes may be formed in package body 14, and the electroplating can be performed, in order to fill in the through-holes to form lead-out terminal 13 of the first winding.

Then, formation steps of the second winding are described, including the following steps. As shown in FIG. 4D, coil body 22 of the second winding copper may be formed by electroplating copper on package body 14. As shown in FIG. 4E, coil body 22 of the second winding can be encapsulated, in order to form package body 24. As shown in FIG. 4F, through-holes may be formed in package body 24, and electroplating can be performed, in order to fill in the through-holes to form lead-out terminal 23 of the second winding.

For example, lead-out terminal 23 of the second winding may be formed by electroplating at the head and tail parts of coil body 22 of the second winding, and lead-out terminal 13 of coil body 12 of the first winding can be formed by electroplating at the same time, and may be drawn to the outside of second encapsulation body 24. When magnetic encapsulation body 16 is formed on the surface of package body 24, and before the formation of magnetic encapsulation body 16, lead terminal 13 of the first winding and lead terminal 23 of the second winding can be electroplated to draw to the outside of magnetic encapsulation body 16.

A third manufacturing step for a transformer structure including two windings is described. This third manufacturing step can be used to form a transformer structure as shown in FIG. 2D. The lead-out terminals of different windings may be exposed to the two opposite sides of the transformer structure, including the following steps. At a first step, two magnetic units including at least one winding can be manufactured. Each winding can include a coil body and a lead-out terminal connected to the coil body. At a second step, the two magnetic units can be stacked back-to-back. At a third step, the stacked magnetic units can be pasted, pressed, and encapsulated.

Here, the magnetic units in first step can adopt the following manufacturing steps. In this embodiment, two substrates including one winding can be formed, two substrates including two windings can be formed, or two substrates including more than two windings, can be formed. Then, one side of the substrate may be encapsulated by a magnetic encapsulation material. As shown in FIG. 2D, the two magnetic units can also be separated by insulating layer 21. The material of insulating layer 21 can include, e.g., epoxy encapsulating material or polyimide. Also, insulating layer 21 and the magnetic unit can be combined by bonding or high temperature pressing.

Further, the lead-out terminals of all windings in the magnetic unit can be drawn to the same side of the substrate. In this case, the one side of the substrate that the lead-out terminal is drawn to in the two magnetic units can be encapsulated by the magnetic encapsulation material, and the other side of the substrate may not be encapsulated. The two magnetic units can be stacked back-to-back on the side without magnetic encapsulation material. In certain embodiments, any suitable way to combine the stacked magnetic units is not limited to the pasting, pressing or overall encapsulation methods listed above.

When the transformer structure is an integral component, the following steps can also be included. A pad can be formed on the surface of the transformer structure to electrically connect with each of the lead-out terminals, such that the transformer structure is connected to the external electrical device through the pad.

When the above-mentioned transformer structure is part of an integrated circuit, the manufacturing method of the integrated circuit can include the following steps. A die can be encapsulated, and the die and the transformer structure can be connected electrically by lead-out terminals of the winding in the transformer structure. In certain embodiments, any suitable way of establishing electrical connection, including wire bounding or rewiring, can be supported.

In particular embodiments, manufacture transformer structures including more than two windings can be formed. In addition, the coil body of each winding can correspond to two lead-out terminals. The examples of FIGS. 2A-2D, 3A-3F, and 4A-4F show each coil body indicating one lead-out terminal, but two or more lead-out terminals can be supported in certain embodiments.

In particular embodiments, the transformer structure can include a substrate encapsulating at least two windings and a magnetic encapsulation body encapsulating at least one side of the substrate. Each winding can include the coil body and the lead-out terminal connected to the coil body. The windings can at least partially overlap in the first direction. Also, the magnetic encapsulation body can include an insulating main material and magnetic particles dispersed in the main material. In particular embodiments, the lead-out terminals of the winding connected to the coil body can be formed by an electroplating process, and at least one side of the substrate may be encapsulated by magnetic encapsulation material. In this way, the less complex transformer can meet ultra-thin and small size requirements, while utilizing a production process, as compared to conventional approaches.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A transformer structure, comprising:
a substrate encapsulating at least two windings, each of which comprising an coil body and lead-out terminals coupled to the coil body; and
a magnetic encapsulation body encapsulating at least one side of the substrate;
wherein the windings are isolated from each other; the magnetic encapsulation body comprises an insulating main material and magnetic particles dispersed in the main material.

2. The transformer structure of claim 1, wherein the magnetic particles comprises at least one of carbonyl iron powder, alloy powder, micro-particle broken ferrite powder and amorphous nanocrystalline powder.

3. The transformer structure of claim 1, wherein a material of the substrate is the same as that of the magnetic encapsulation body.

4. The transformer structure of claim 1, wherein lead-out terminals are drawn to the same surface of the transformer structure or to the opposite two surfaces of the transformer structure.

5. The transformer structure of claim 1, wherein the transformer structure comprises an insulating layer disposed between two adjacent windings.

6. The transformer structure of claim 5, wherein a material of the insulating layer comprises one of epoxy packaging material and polyimide.

7. The transformer structure of claim 1, wherein both sides of the substrate are encapsulated by the magnetic encapsulation bodies.

8. The transformer structure of claim 5, wherein the lead-out terminals of the windings on both sides of the insulating layer are respectively drawn to the opposite two surfaces of the transformer structure.

9. The transformer structure of claim 1, wherein when only one side of the substrate is encapsulated with the magnetic encapsulation body, the other side of the substrate is attached with a magnetic sheet, and the magnetic sheet covers at least part of the region of all coil bodies.

10. The transformer structure of claim 1, wherein an outer surface of the transformer structure is also provided with a pad for electrical connection with each of the lead-out terminals.

11. A manufacturing method for a transformer structure, comprising:
forming a substrate comprising at least two windings, wherein each winding comprises a coil body and a lead-out terminal coupled to the coil body; and
encapsulating at least one side of the substrate by a magnetic encapsulation body;
wherein the windings are formed by a corresponding electroplating process in sequence, after one winding is formed, the winding is encapsulated to form the magnetic encapsulation body; the windings are isolated from each other; and the magnetic encapsulation body comprises an insulating main material and magnetic particles dispersed in the main material.

12. The manufacturing method of claim 11, wherein the magnetic particles comprises at least one of carbonyl iron powder, alloy powder, micro-particle broken ferrite powder and amorphous nanocrystalline powder.

13. The manufacturing method of claim 11, wherein a material of the substrate is the same as that of the magnetic encapsulation body.

14. The manufacturing method of claim 11, further comprising:
attaching the other side of the substrate with a magnetic sheet when only one side of the substrate is encapsulated with magnetic encapsulation material, wherein the magnetic sheet covers at least part of the region of all coil bodies of the transformer structure.

15. The manufacturing method of claim 11, wherein the magnetic sheet comprises one of ferrite and magnetic powder core.

16. The manufacturing method of claim 11, comprising:
forming the coil body of the current winding by copper plating on a base-plate or the magnetic encapsulation body enclosing the previous winding;
forming copper columns by electroplating on the head and the tail parts of the coil body of the current winding, wherein the copper column are configured as the lead-out terminals of the current winding; and
forming the encapsulation body by encapsulating the current coil body and the lead-out terminal.

17. The manufacturing method of claim 11, comprising:
forming the coil body of the current winding by performing an electroplating process on the base-plate or the magnetic encapsulation body enclosing the previous winding:
encapsulating the coil body of the current winding to form the magnetic encapsulation body;
forming through-holes in the current encapsulation body, and
performing electroplating to fill in the through-holes to form the lead-out terminals of the current winding and the previous winding.

18. The manufacturing method of claim 16 or 17, comprising:
forming a first patterned photoresist on the base-plate or on the encapsulation body of the previous winding; and
forming a first metal layer on the exposed part of the base-plate by the first patterned photoresist or on the encapsulation body enclosing the previous winding to form the coil body.

19. The manufacturing method of claim 16, comprising:
forming a second patterned photoresist on an upper surface of the coil body; and
electroplating a second metal layer on the exposed part of the coil body by the second photoresist to form the lead-out terminal.

20. A manufacturing method for a transformer structure, comprising:
manufacturing two magnetic units comprising at least one winding; wherein each winding comprises a coil body and a lead-out terminal coupled to the coil body;
wherein two magnetic units are stacked back to back; and
the manufacturing magnetic unit comprises:
forming the winding by electroplating process;
encapsulating the winding to form a substrate comprising at least one winding; and
encapsulating one side of the substrate by a magnetic encapsulation body;
wherein the magnetic encapsulation body comprises an insulating main material and magnetic particles dispersed in the main material.

21. The manufacturing method of claim 20, wherein the two magnetic units are isolated by an insulating layer.

22. The manufacturing method of claim 21, wherein a material of the insulating layer comprises one of the epoxy packaging materials and polyimide.

23. The manufacturing method of claim 21, wherein the insulating layer and the magnetic unit are combined by bonding or high temperature pressing.

24. The manufacturing method of claim 21, comprising performing one of pasting, pressing or encapsulating on the stacked magnetic units.

25. An integrated circuit, comprising:
a die; and
the transformer structure of the claims 1˜10; wherein the die is connected electrically to the transformer structure by the lead-out terminal that is drawn to the surface of the transformer structure.
